(19) United States
(12) Patent Application Publication
(10) Pub. No.: US 2018/0042370 A1
(43) Pub. Date: Feb. 15, 2018

(54) CLIP FOR HOLDING UTENSILS IN TACTICAL GEAR SYSTEMS

(71) Applicants: Amos CASTEDO GOMEZ, Albacete (SP); Vicente Luis MOSCARDO BOLUFER, Albacete (SP)

(72) Inventors: Amos CASTEDO GOMEZ, Albacete (SP); Vicente Luis MOSCARDO BOLUFER, Albacete (SP)

(21) Appl. No.: 15/232,226

(22) Filed: Aug. 9, 2016

(51) Int. Cl. A45F 5/02; F16B 2/20

(52) U.S. Cl. CPC A45F 5/021; F16B 2/20

(57) ABSTRACT

A clip is provided for holding utensils in tactical gear systems and, more specifically, to a clip envisaged for fixing to a belt or strap to carry the elements required for holding accessories such as hammers, torches, water bottles, etc., used in open air military campaigns, in marches and/or excursions and, in general, in any other operation where the users need to carry different types of accessories that must be easily accessible. The clip includes two pieces connected by a hinge and having closing members in the form of hooks and a manually actuated cam to immobile a closing sliding piece.

### OBJECT OF THE INVENTION

The present invention relates to a clip for holding utensils in tactical gear systems and, more specifically, to a clip envisaged for fixing to a belt or strap to carry the elements required for holding accessories such as hammers, torches, water bottles, etc., used in open air military campaigns, in marches and/or excursions and, in general, in any other operation where the users need to carry different types of accessories that must be easily accessible.

### BACKGROUND OF THE INVENTION

The existence of classic clips for holding utensils in tactical gear systems is known, said clips being based on two pieces having a general rectangular configuration, hinged on one of their edges and having, on the edge opposite the hinged edge, hooking and closing means for maintaining said pieces joined together duly stabilised to a strap or belt, such that at least one of said pieces includes a series of holes that make it possible to hold different types of accessories using Chicago-type screws.

These types of clips have the drawback that they may open accidentally; in addition, the shape and arrangement of their holes is not the most suitable for allowing a maximum number of positions or fixation method of the different accessories intended to be held by means of said clip.

Additionally, the constituent parts of the clip are completely flat, without possibility of adapting to curved anatomical configurations, such as an arm, a leg, etc.

### DESCRIPTION OF THE INVENTION

The clip advocated herein has been designed to resolve the previously expounded problems, based on a simple but extremely effective structure.

To this end and more specifically, the device of the invention, based on a structure made up of rectangular pieces hinged together through one of their edges and having closing means on the opposite edge, in addition to holes for inserting accessories, has the peculiarity of having blockable closing means without possibility of opening accidentally.

In this regard, the closing means are characterised in that they consist of a pair of elements in the manner of hooks related to a sliding closing piece required towards an operational or blocking position by means of an internal spring, such that when said elements are housed in the manner of hooks in respective holes existing in the complementary clip piece, the sliding piece having closing functions, by means of the spring, tends to maintain said hooks in the closed position, such that in order to prevent the accidental opening of the clip by exerting pressure on the pressing element of the sliding piece having closing functions, the inclusion of a manually actuated cam has been envisaged, which is disposed on the piece containing said holes and which acts upon one of the side walls of one of the hooks, preventing it from moving and therefore blocking the entire closing mechanism, without possibility of opening accidentally without releasing the cam and pushing the corresponding pressing element associated to the sliding piece having closing functions.

Additionally, the piece with holes wherein the hooks are coupled has, on its inner side, a pair of cross members movable over guides envisaged for such purpose on said inner side, elements that constitute corresponding adjustment means so that the strap in question can be correctly positioned therebetween, thereby adapting the clip to straps and belts of different thicknesses in a completely stable manner.

It has also been envisaged that, by virtue of the arrangement and number of holes, in addition to the configuration of one of the pieces of the two that constitute the main body of the clip, an angular multipositioning of the different accessories in their arrangement thereon may be carried out, since said multiangular multipositioning is not limited to rotation positions of 90° as in the case of other conventional clips.

Lastly, it should be noted that the clip is modular in nature to achieve the full disassembly of the assembly and will be materialised using non-metallic materials, not susceptible to corrosion or wear in hostile environments.

Likewise, it should be noted that the piece that acts as a rear piece of the two that constitute the clip is slightly concave, enabling an ergonomic arrangement, whether on the user's arm, leg, chest or back.

### DESCRIPTION OF THE DRAWINGS

In order to complement the following description and with the object of helping to better understand the characteristics of the invention, in accordance with a preferred embodiment thereof, said description is accompanied, as an integral part thereof, by a set of drawings where, in an illustrative and non-limiting manner, the following has been represented:

FIG. 1 shows a representation corresponding to a perspective view of a clip for holding utensils in tactical gear systems embodied in accordance with the object of the present invention, disposed in the open position for such purpose.

FIG. 2 shows a global view of the assembly of the foregoing figure in accordance with a perspective having a different angular orientation

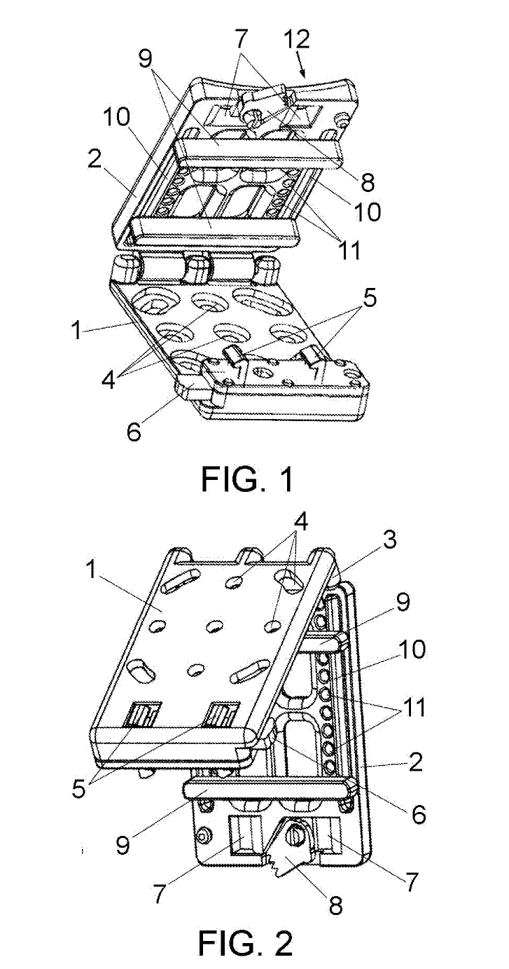

### PREFERRED EMBODIMENT OF THE INVENTION

As can be observed in the foregoing figures, the clip for holding utensils in tactical gear systems advocated herein consists of the interhinging of two pieces (1) and (2), both rectangular, hinged by means of corresponding articulation means (3), on one of their edges, allowing the disassembly and easy assembly thereof.

The piece (1) that constitutes the front of the clip is affected by a plurality of holes (4) for fixing accessories by means of Chicago-type screws and has a closing piece with hooks (5), axially movable and required by an internal spring, having a pressing element (6) for carrying out said axial movement against the tension of the aforementioned spring.

The hooks (5) are envisaged to be coupled to windows (7) established for such purpose on the rear piece (2) in order to close the clip.

In order to prevent the clip from opening accidentally, the inclusion of a cam (8) has been envisaged at the same level as the aforementioned windows (7) which, in the closed position, rotates so as to lean on the lateral face of one of the hooks (5), acting as a stop, thereby preventing said closing assembly from moving axially in the event of accidentally pressing the pressing element (6).

Therefore, until the cam (8) is not rotated towards the release position of the hooks (5), they cannot be released from the windows (7) due to the action of the pressing element (6).

In accordance with another characteristic of the invention, the clip may be adapted to different types of straps of multiple thicknesses, to which end it has cross members (9) movable over the internal piece (2), enabling its separation or approximation by means of guides (10), thereby adapting to the exact width of the strap or belt whereto the clip is fixed, also having an alignment of holes (11) established collaterally to the guides (10), whereon said cross members (9) can be immobilised.

Lastly, it should be noted that the inner face of the internal piece (2) has a slightly concave curved configuration (12), which facilitates its ergonomic adaptation to curved surfaces, such as arms, legs, chest, etc.

1. A clip for holding utensils in tactical strap systems, consisting of two essentially rectangular pieces articulately related to each other by means of hinging envisaged in correspondence with one of the ends of corresponding pieces, having closing means in correspondence with the opposite end to that of the hinging means, in addition to having holes for arranging different types of accessories by means of screws, characterised in that the closing means between the two pieces consist of elements in the manner of hooks emerging from a closing sliding piece required towards an operational or blocking position by means of an internal spring, said hooks being complementary to windows established in correspondence on the opposite piece, with the peculiarity that in said piece wherein the windows for blocking the hooks are established, a manually actuated cam is disposed which, in the blocked position, acts on one of the side walls of one of the hooks, immobilising the closing sliding piece.

2. The clip for holding utensils in tactical strap systems, according to claim 1, characterised in that in one of the main pieces of the clip, specifically that which defines the back thereof, two movable cross members have been envisaged for adjusting the clip to straps or belts of different thicknesses, said cross members being disposed on lateral guides of the pieces whereon they are mounted and being blockable in different positions by means of alignments of holes wherein they can be fitted.

3. The clip for holding utensils in tactical strap systems, according to claim 1, characterised in that the piece that defines the back of the clip has, on the back thereof, a concave curved surface for the ergonomic adaptation thereof.

4. The clip for holding utensils in tactical strap systems, according to claim 2, characterised in that the piece that defines the back of the clip has, on the back thereof, a concave curved surface for the ergonomic adaptation thereof.
